(19) United States
(12) Patent Application Publication
(10) Pub. No.: US 2013/0038995 A1
(43) Pub. Date: Feb. 14, 2013

(54) HANGING SUPPORT FOR TABLET/NOTEBOOK COMPUTER

(71) Applicant: Chuan-Chung Fang, New Taipei City (TW)

(72) Inventor: Chuan-Chung Fang, New Taipei City (TW)

(21) Appl. No.: 13/206,716

(22) Filed: Aug. 10, 2011

(51) Int. Cl. G06F 1/16

(52) U.S. Cl. 361/679.03

(57) ABSTRACT

A hanging support for working with a tablet computer or a notebook computer is provided. The hanging support is composed of a base plate and a hanging strip. The base plate for supporting the tablet/notebook computer has an expandable supporting board. When the base plate can be positioned to provide an inclined supporting plane or the supporting board can be expanded to support the computer, so that a user can hang the computer in front of his/her body with the hanging strip and use both of his/her hands to operate the computer.

### BACKGROUND OF THE INVENTION

1. Technical Field

The present invention relates to auxiliary devices for tablet/notebook computers, and more particularly, to a hanging support composed of a base plate and a hanging strip for a user to carry and use a tablet/notebook computer, wherein the base plate can be positioned to provide an inclined supporting plane or its supporting board can be expanded, so that with the assistance of the hanging strip, a user can hang the computer in front of his/her body and use his/her both hands to operate the computer.

2. Description of Related Art

Smart phones, tablet computers and notebook computers supporting 3G communication are some of the most popular modern information products because they are highly mobile and can be conveniently used almost everywhere.

A 3G phone supporting web-browsing functions is typically compact in volume and light in weight, so a user can easily hold it with one hand and operate it with the other hand. In addition, since its screen is limited in area, there is generally no need to operate it with the user's both hands. On the other hand, when using a tablet computer, a user has to hold the computer in one hand with or without additional support such as that obtained by resting the hand on an external object or one of the user's legs, and operate the computer with the other hand. Since such a computer is relatively large and heavy, holding it in a single hand brings about the risk of unstableness, and tends to cause a tired arm and/or carpal tunnel syndrome. Also, holding an operating computer in hand is adverse to heat dissipation of the computer. Moreover, the tablet computer can be easily dropped from the hand and break. A notebook computer is even larger and heavier as compared with the foregoing two mobile devices, and is usually put on a desk or a user's laps for use. This has the disadvantages including making the computer unstable, causing inconvenience in terms of typing, hurting the user's visual health, hindering heat dissipation of the computer, tending to burn the user's skin, and risking the computer from accidental drop.

In general, when using tablet/notebook computers, users who are not sitting before desks can either stand or lean with the computers held in hand or sit with the computers put on laps. Each of the positions can endanger the tablet/notebook computer with the foregoing risks.

However, there is not an auxiliary device for working with a tablet computer or a notebook computer, so it would be desirable to create a functional auxiliary device that brings convenience to all users of tablet/notebook computers.

### SUMMARY OF THE INVENTION

As described above, a tablet/notebook computer features for its mobility and can be used almost everywhere, so it is more often at various places held by a user in hand or put on a user's laps instead of being settled on a desk. In view of this, the inventor of the present invention has invented a device facilitating the use of a tablet/notebook computer.

The present invention uses a base plate and a hanging strip to compose the disclosed hanging support. The base plate serves to support a tablet/notebook computer, and has its inner edge provided with a rotatably expandable supporting board. The expanded supporting board can incline for positioning. Alternatively, the supporting board can be expanded and work with the hanging strip, so as to allow a user to hang the tablet/notebook computer in front of his/her body and uses his/her both hands to operate the computer.

With the base plate having the expandable supporting board plus the hanging strip, a user can operate the tablet/notebook computer in any position without the concern of dropping the computer accidently. Meanwhile, the user can view the computer with a viewing angle and distance closer to recommended ones, so as to minimize additional visual burden. Also, the user can have his/her both hands freely operating the tablet/notebook computer, thereby reducing the risk of carpal tunnel syndrome.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 according to the present invention provides a top view and a side view of a hanging support for a tablet computer or for a notebook computer, which is retracted;

FIG. 2 is a rear view and a front view of the hanging support that is retracted;

FIG. 3 is a perspective view of the hanging support of the present invention that is expanded to provide an inclined supporting surface for a tablet computer or for a notebook computer;

FIG. 4 is an applied view of the hanging support of FIG. 3 supporting a tablet computer;

FIG. 5 is an applied view of the hanging support of FIG. 3 supporting a notebook computer;

FIG. 6 is a schematic drawing showing the hanging support of the present invention having its supporting board expanded;

FIG. 7 is a cross-sectional view of the hanging support of the present invention showing the relative position of its base plate and supporting board;

FIG. 8 is a front view of a retainer of a positioning rod of the hanging support according to the present invention;

FIG. 9 is a schematic drawing showing the retainer of the positioning rod of the present invention engaging with the supporting board;

FIG. 10 shows the hanging support of FIG. 6 supporting a notebook computer;

FIG. 11 depicts a standing user wearing the hanging support of the present invention that has the supporting board expanded for supporting a tablet computer thereon;

FIG. 12 depicts a standing user wearing the hanging support of the present invention that has the supporting board expanded for supporting a notebook computer thereon;

FIG. 13 depicts a back of a standing user wearing the hanging strip of the hanging support of the present invention on his/her shoulders;

FIG. 14 depicts a user sitting on a chair and wearing the hanging support of the present invention that has the supporting board expanded for supporting a tablet computer thereon;

FIG. 15 depicts a user sitting on a chair and wearing the hanging support of the present invention that has the supporting board expanded for supporting a notebook computer thereon;

FIG. 16 depicts a user sitting on a rocking chair and wearing the hanging support of the present invention that has the supporting board expanded for supporting a tablet computer thereon;

FIG. 17 depicts a user sitting on a rocking chair and wearing the hanging support of the present invention that has the supporting board expanded for supporting a notebook computer thereon;

FIG. 18 depicts a user sitting on the ground and wearing the hanging support of the present invention that has the supporting board expanded for supporting a tablet computer thereon; and

FIG. 19 depicts a user sitting on the ground and wearing the hanging support of the present invention that has the supporting board expanded for supporting a notebook computer thereon.

### DETAILED DESCRIPTION OF THE INVENTION

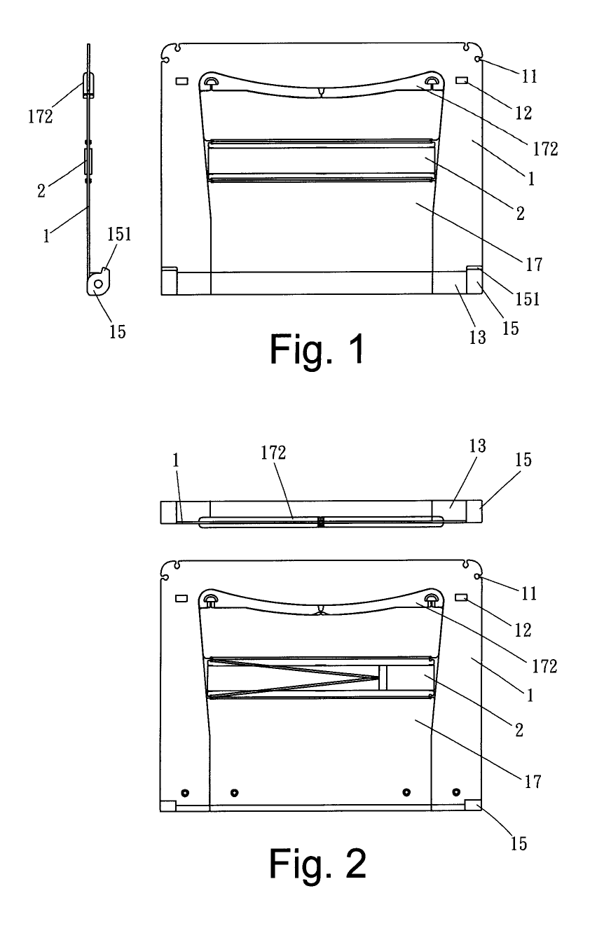

Referring to FIG. 1 and FIG. 2, according to the present invention, a hanging support for working with a tablet/notebook computer is primarily composed of a base plate (1) and a hanging strip (2). The base plate (1) has its two front corners formed with a plurality of engaging holes (11). The base plate (1) further has two symmetrical positioning holes (12) near the two front corners. The base plate (1) has a tube (13) extended along its rear edge. The tube (13) receives therein a positioning rod (14). The positioning rod (14) extends through the tube (13) and coupled to a lever (15) that controls the positioning rod (14). A spring (141) may be mounted around the positioning rod (14) and held by a retainer (142) coupled to the positioning rod (14).

The lever (15) has its periphery formed with a block (151). When placed on the base plate (1), a tablet computer (P) or a notebook computer (N) has its lower edge abutting against the tube (13) and being further retained by the block (151), so as to prevent the lower edge of the tablet computer (P) or notebook computer (N) from tilting, thereby stabilizing the computer.

The base plate (1) is internally formed with an opening (16) for fittingly receiving a supporting board (17). The supporting board (17) is configured to pivot on the tube (13) of the base plate (1), so that the base plate (1) and the supporting board (17) are coupled mutually, allowing the supporting board (17) to be expanded or retrieved with respect to the base plate (1).

The supporting board (17) has each of its two front corners provide with a supporting pivot (171) and the supporting pivot (171) may be covered by a shield (172) that is shaped to be level with the front edge of the supporting board (17), or can be rotated to form pedestals supporting the base plate (1). The supporting board (17) has its two lateral edges formed with corresponding notches (173).

The hanging strip (2) has its two ends fixed to the supporting board (17), and the hanging strip (2), when not in use, can be wound around the supporting board (17) and retained by the notches (173).

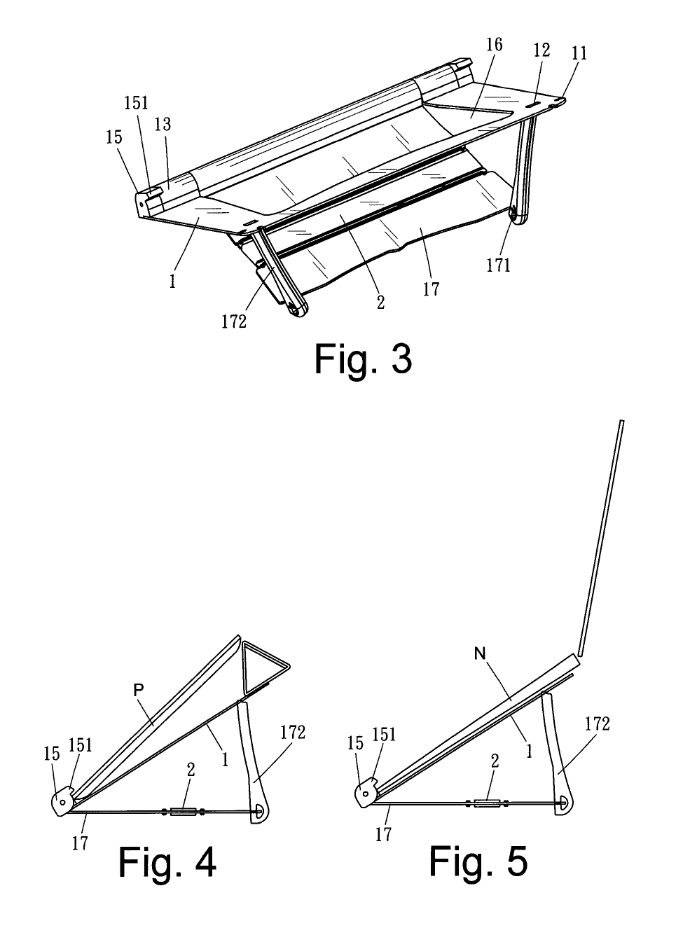

As shown in FIG. 3 through FIG. 5, the supporting board (17) of the base plate (1) can be first rotatably expanded and then the shield (172) can be rotated to have its tail engaging with the positioning holes (12) of the base plate (1), so as to pose the base plate (1) as a computer support with an inclined supporting surface, on which a tablet computer (P) or a notebook computer (N) can be placed.

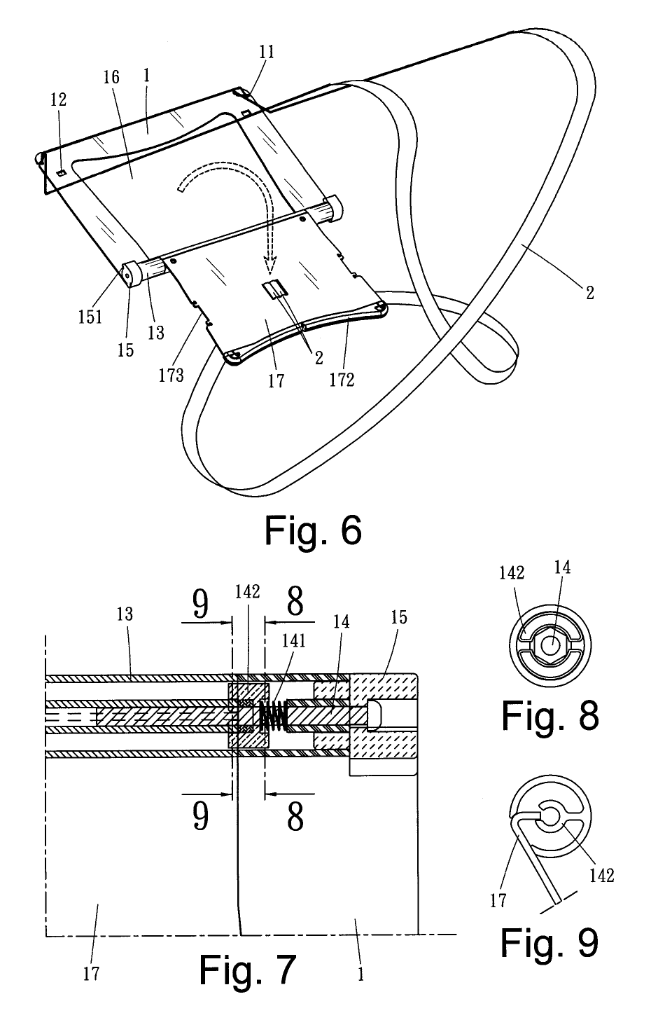

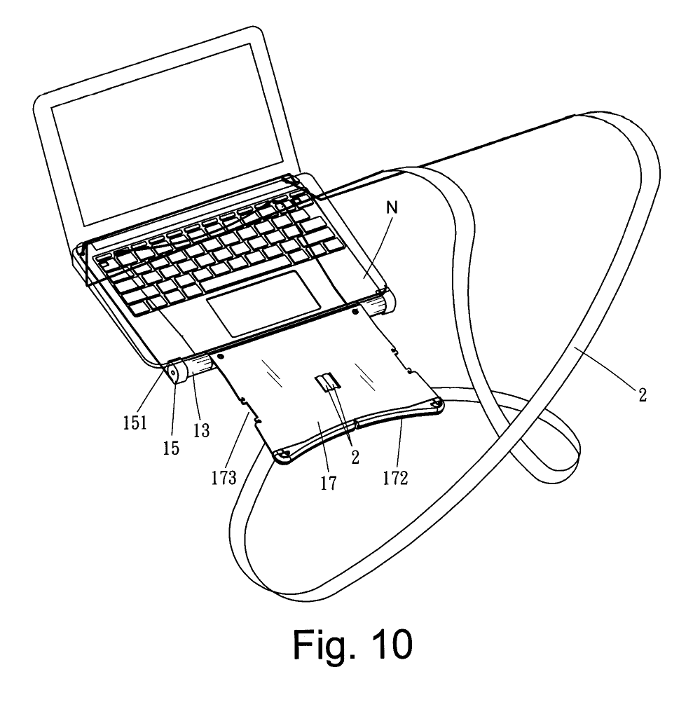

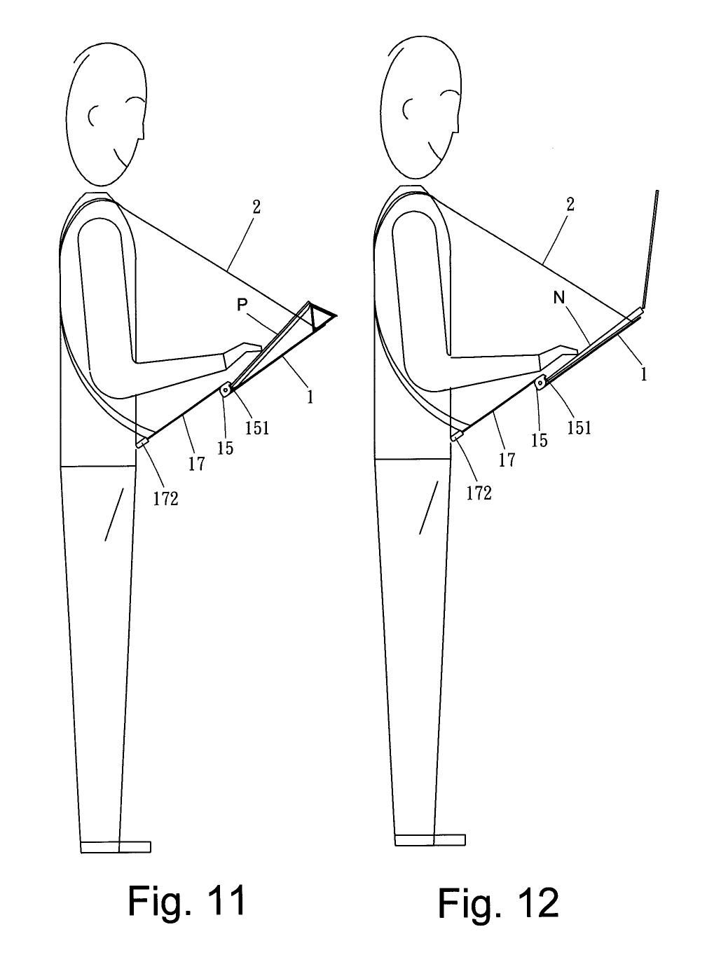

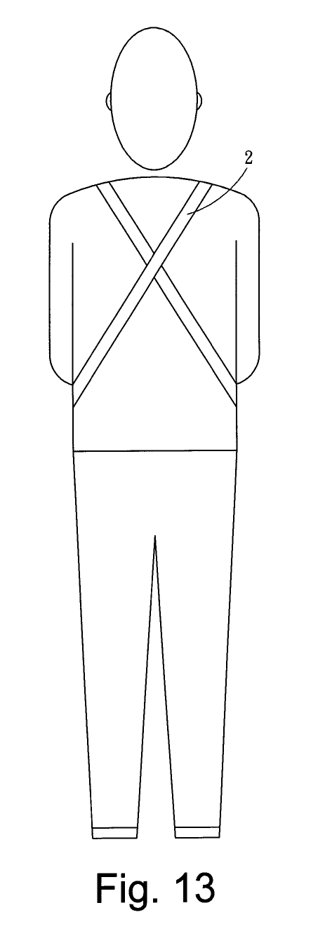

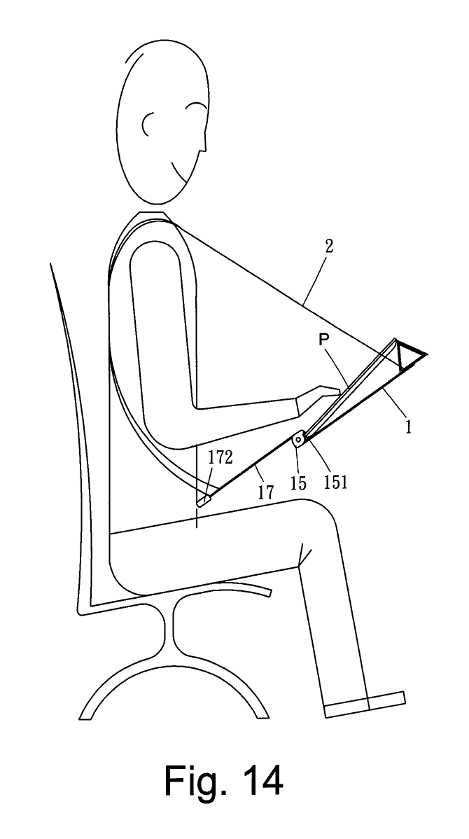

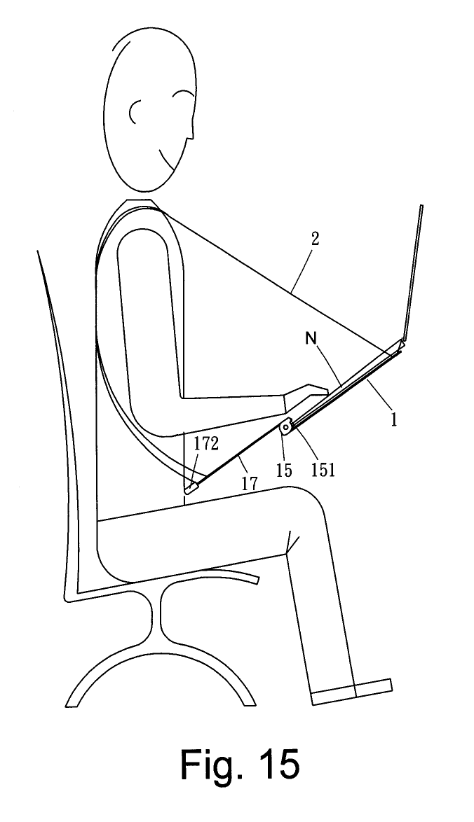

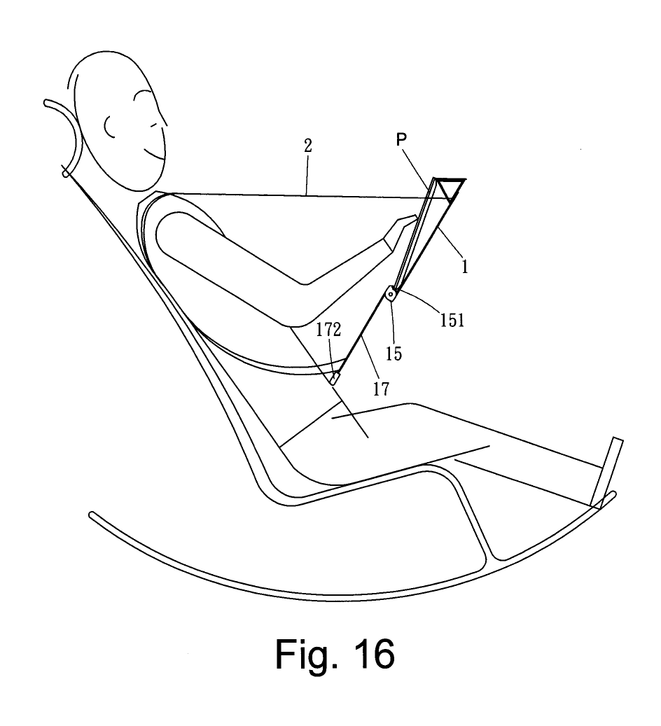

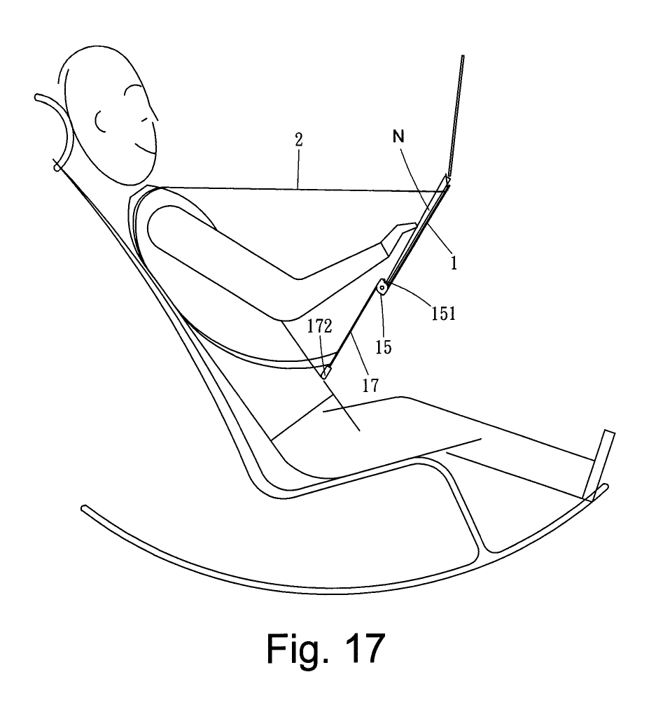

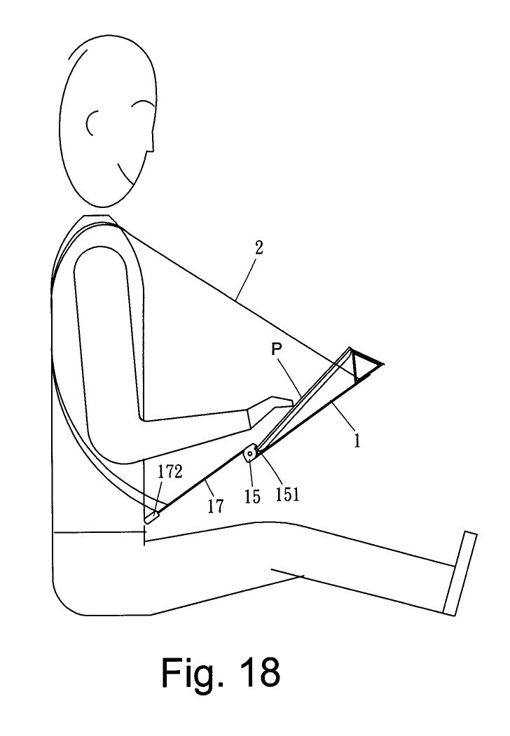

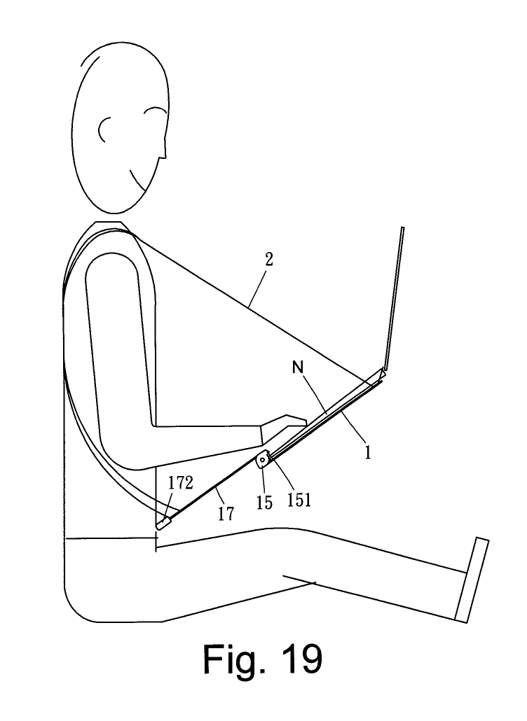

Referring to FIG. 6, the supporting board (14) can be rotated about 180 degrees with respect to the base plate (1). As shown in FIG. 7 through FIG. 9, the lever (15) controls the retainer (142) of the positioning rod (14) to engage and thereby position the supporting board (17). The user can then unfold and shoulder the hanging strip (2), and cross the hanging strip (2) over the base plate (1) before engaging it with the engaging holes (11), so that the supporting board (17) has the end with the shield (172) leaning on the user's belly, as shown in FIG. 10. Thereby, the user can stably position the tablet computer (P) or the notebook computer (N) on the base plate (1) and uses the block (151) of the lever (15) to retain the lower edge of the tablet computer (P) or the notebook computer (N), so that the user can hold the computer in any body postures while using his/her both hands to operate the computer. FIG. 11 through FIG. 19 depict a user carrying the computer in various body postures.

What is claimed is:

1. A hanging support for supporting a tablet computer or a notebook computer, the hanging support primarily comprising a base plate (1) and a hanging strip (2);
the base plate (1) having front corners thereof formed with engaging holes (11) and having a tube (13) extending along a rear edge thereof, the tube (13) receiving a positioning rod (14), the positioning rod (14) extending to tow ends of the tube (13) and being coupled with a lever (15), the lever (15) being configured to rotate the positioning rod (14), the positioning rod (14) having being terminally capped by a retainer (142), the base plate (1) having an inner edge formed with an opening (16), the opening (16) receiving a supporting board (17) of a matching shape, and the supporting board (17) being pivotable on the tube (13) of the base plate (1) and thereby being connected with the supporting board (17), so that the supporting board (17) being allowed to be expanded or retracted; and
the hanging strip (2) having two ends fixed to the supporting board (17),
wherein when the supporting board (14) is rotated about 180 degrees with respect to the base plate (1) and thus expanded, the lever (15) serves to control the retainer (142) of the positioning rod (14) to engage with and thereby position the supporting board (17), and then the hanging strip (2) is unfolded and shouldered by a user before crossing over the base plate (1) and being engaged with the engaging holes (11), whereby the user is allowed to stably position the tablet computer (P) or the notebook computer (N) on the base plate (1) and hold the computer in any body postures while using his/her both hands to operate the computer.

2. The hanging support of claim 1, wherein the base plate (1) includes symmetrical positioning holes (12) formed near the front corners, the supporting board (17) having each of two front corners thereof provided with a supporting pivot (171), a shield (172) being mounted around the supporting pivot (171) so that the shield (172) is level with a front edge of the supporting board (17) for serving as shield abutting against the user's belly, or is rotated to form a supporting pedestal for supporting the base plate (1),
wherein the base plate (1) is allowed to be rotated with respect to the supporting board (17) for an angle, and then the shield (172) is rotated to have a tail thereof retained in the positioning holes (12) of the base plate (1), so that the base plate (1) provide an inclined supporting surface for supporting the tablet computer (P) or the notebook computer (N) thereon.

3. The hanging support of claim 1, wherein the supporting board (17) has two lateral edges thereof formed with corresponding notches (173) so that the hanging strip (2), when not in use, is wound around the supporting board (17) and retained by the notches (173).

4. The hanging support of claim 1, wherein the lever (15) has a periphery thereof formed with a block (151), so that when placed on the base plate (1), the tablet computer (P) or the notebook computer (N) has a lower edge thereof abutting against the tube (13) and being further retained by the block (151), so as to prevent the lower edge of the tablet computer (P) or notebook computer (N) from tilting, thereby stabilizing the computer.
